(19) United States
(12) Patent Application Publication
(10) Pub. No.: US 2024/0241735 A1
(43) Pub. Date: Jul. 18, 2024

(54) RUNTIME SUPPORT FOR LINK TYPE OBJECT MANAGEMENT

(71) Applicant: Zoho Corporation Private Limited, Kanchipuram District (IN)

(72) Inventors: Sridhar Vembu, Tenkasi (IN); Akshhayaa S, Guduvanchery (IN); Vanaja Ramaswamy, Chennai (IN); Padma J, Chennai (IN); Shalini Lakshmi A J, Chennai (IN); Siba Mishra, Puri (IN); Subathra Periakaruppan, Madurai (IN); Joseph Sathya Kumar, Chennai (IN); Balamurugan R, Chennai (IN); Balamurugan K E, Chennai (IN); Arvind Sudarshan K, Chennai (IN); Suresh K V, Chengalpet District (IN); Baradhan V, Theni (IN); Sudheer A. Grandhi, Pleasanton, CA (US)

(73) Assignee: Zoho Corporation Private Limited, Kanchipuram District (IN)

(21) Appl. No.: 18/405,916

(22) Filed: Jan. 5, 2024

Related U.S. Application Data
(60) Provisional application No. 63/579,472, filed on Aug. 29, 2023.
(60) Provisional application No. 63/487,362, filed on Feb. 28, 2023.

(30) Foreign Application Priority Data
Jan. 13, 2023 (IN) 202341002897
Sep. 5, 2023 (IN) 202341059666
Nov. 20, 2023 (IN) 202341078771

(51) Int. Cl. G06F 9/448; G06F 8/20; G06F 8/41

(52) U.S. Cl. CPC G06F 9/4488; G06F 8/24; G06F 8/437

(57) ABSTRACT

A compile-time link type manager is defined to facilitate development of source code with disciplined link type object management at run-time. In one aspect, when a compile-time link type manager encounters a link type object management construct in source code, it will emit code for a runtime object management engine that processes generic link type object management instructions at runtime. It will also compile type-specific instructions from the link type object management construct for accessing the generic instructions in the runtime object management engine for affecting a link type object at runtime. A runtime object management engine may perform various checks, referred to as link-type criteria, at runtime prior to executing a link type object management instruction. When defined link-type criteria are satisfied for a link type object management instruction for an object at runtime, the instruction is carried out.

### CROSS REFERENCE TO RELATED APPLICATION

This application is related to Indian Provisional Application 202341078771 filed 20 Nov. 2023, entitled “RUNTIME SUPPORT FOR LINK TYPES OBJECT MANAGEMENT,” which is incorporated herein by reference.

### FIELD OF THE INVENTION

Embodiments of the present disclosure are related, in general, to computer programming languages and more particularly, but not exclusively, to runtime management of link types.

### BACKGROUND

At the source code level, user-defined types pertain to structures, classes, interfaces, and other composite data types that programmers define to represent and manipulate complex data structures more effectively. These types go beyond the basic data types like int, float, and char that most languages offer inherently. User-defined types allow for the encapsulation of data and related functionality into cohesive units. At compile time, the compiler checks these types for syntactic and semantic correctness. This includes ensuring that the members of a class or structure are correctly defined, that methods are properly declared and implemented, and that any inheritance or interface implementation is correctly specified. The primary goal during this phase is to ensure that the code adheres to the language's syntax and semantics, and if it doesn't, to provide meaningful feedback to the developer.

Once the source code is compiled and becomes an executable, the user-defined types are transformed into machine code, ready for execution. At runtime, when these types are instantiated, memory is allocated for the resulting objects. For languages with manual memory management like C++, the developer allocates memory for objects using constructs like ‘new’ and releases memory with ‘delete’. In contrast, languages with garbage collection, such as Java or C#, handle memory deallocation automatically once objects are no longer reachable. The runtime environment is responsible for managing the object lifecycle, ensuring that constructors are called when an object is created, and destructors (if applicable) are called when an object is destroyed. The management of these objects and the execution of associated methods form the core of runtime object management based on user-defined types.

### BRIEF DESCRIPTION OF THE DRAWINGS

The subject matter disclosed is illustrated by way of example, and not by way of limitation, in the figures of the accompanying drawings and in which like reference numerals refer to similar elements and in which:

FIG. 1 is a flowchart 100 illustrating the function of a compile-time link type manager emitting a runtime management engine for a link type object management construct at compile time.

FIGS. 2A and 2B illustrate how source code 200 written in accordance with one embodiment is compiled into an Intermediate Representation (IR) 205.

FIG. 3 illustrates a run-time environment in which a computer having a memory 300 is loaded with executable programs to facilitate object management.

FIG. 4A is a flowchart 400 illustrating how a compiler passes through several phases to convert source code written in a high-level language into machine code, including enforcing rules for managing link types at compile time.

FIG. 4B depicts compile-time link type manager 420 of FIG. 4A in accordance with one embodiment.

FIG. 5 is a flowchart 500 illustrating functions of IDT creation compile-time check 452 of FIG. 4B.

FIG. 6A is a flowchart 600 illustrating functions of IDT creation runtime check 482 of FIG. 4B in one embodiment.

FIG. 6B illustrates a modification to flowchart 600 to include IDT creation constraints.

FIG. 7 is a flowchart 700 illustrating functions of IDT creation runtime check 482 of FIG. 4B in an alternate embodiment.

FIG. 8 is a flowchart 800 illustrating functions of DDT creation compile-time check 454 of FIG. 4B.

FIG. 9 is a flowchart 900 illustrating functions of DDT creation runtime check 484 of FIG. 4B in one embodiment.

FIG. 10 is a flowchart 1000 illustrating functions of DDT creation runtime check 484 of FIG. 4B in an alternate embodiment.

FIG. 11 is a flowchart 1100 illustrating functions of IDT deletion compile-time check 456 of FIG. 4B.

FIG. 12 is a flowchart 1200 illustrating functions of IDT deletion runtime check 486 of FIG. 4B in one embodiment.

FIG. 13 is a flowchart 1300 illustrating an alternate embodiment of IDT deletion runtime check 486.

FIG. 14 is a flowchart 1400 illustrating an embodiment of IDT deletion runtime check 486 introducing constraints.

FIG. 15 is a flowchart 1500 illustrating an alternate embodiment of IDT deletion runtime check 486.

FIG. 16 is a flowchart 1600 illustrating functions of DDT deletion compile-time check 458 of FIG. 4B.

FIG. 17 is a flowchart 1700 illustrating functions of DDT deletion runtime check 488 of FIG. 4B in one embodiment.

FIG. 18 is a flowchart 1800 illustrating functions of a DDT deletion runtime check 488 embodiment with user confirmation included.

FIG. 19 is a flowchart 1900 illustrating an alternate embodiment of DDT deletion runtime check 488 with the user confirmation event.

FIG. 20 illustrates a memory 300 during runtime following various example link type object management instructions, such as IDT and DDT creations and deletions.

FIG. 21 depicts a prior art general-purpose computing system 2100.

### DETAILED DESCRIPTION

A programming language provides for user defined types, which, when compiled, produce instructions for the use of objects of the defined type. Inheritance and type extensions support program maintenance and extensibility. Link types are defined wherein an Independent Data Type (IDT) is referenced in defining a Dependent-link Data Type (DDT). Examples of link types and dependencies, referred to therein as role sharing types and dependencies, are detailed in U.S. patent application Ser. No. 18/335,035 to Sridhar Vembu et al., filed 14 Jun. 2023, and entitled “Role Extensions For Programming Languages,” which is incorporated herein by reference. Role sharing objects in the '035 application are referred to as linked objects herein. Linked objects may alternately be referred to as link or link-type objects. The types defined to instantiate linked objects are referred to as linked types. Described further below, an IDT object and a DDT object are linked, each is a link object, even though one is dependent upon the other. The terminology role-sharing and link terminology are interchangeable. The use of link herein does not imply any difference in capability, function, or scope.

Management functions are defined for creating, deleting, or updating objects based on user-defined types at run time. Each type is defined in source code. Source code also includes link type object management constructs to manage link type objects at run time. A variety of link type object management constructs can be defined for a programming language. For example, a create construct compiles into instructions that instantiate an object into physical memory during runtime, and a delete construct compiles into instructions that deletes an object and frees up physical memory during runtime.

A compile-time link type manager is defined to facilitate development of source code with disciplined link type object management at run-time. In one aspect, when a compile-time link type manager encounters a link type object management construct in source code, it will emit code for a runtime object management engine that processes generic link type object management instructions at runtime. It will also compile type-specific instructions from the link type object management construct for accessing the generic instructions in the runtime object management engine for affecting a link type object at runtime.

A runtime object management engine may perform various checks at runtime prior to executing a link type object management instruction. A variety of checks may be defined for different types and constructs, which are referred to generally as link-type criteria. When defined link-type criteria are satisfied for a link type object management instruction for an object at runtime, the instruction is carried out.

Link-type criteria may include determining the existence of an independent data type object at runtime, either to avoid creating a duplicate of that IDT object, or to determine whether an IDT exists for linking to a DDT pursuant to a DDT create instruction. Link-type criteria may include determining the existence of one or more DDT objects linked to an IDT object prior to deleting the IDT object.

Link-type criteria may include constraints defined for IDT or DDT objects which are evaluated at runtime and where the constraint, when evaluated to an indicative result, prevents the creation, deletion, or updating of an object. When a create instruction is encountered for an existing object, IDT or DDT, values supplied with the create instruction can be compared with those of the existing object, and the existing object can be updated, perhaps conditionally, with the newer values when they differ.

A user confirmation event setting can be utilized to enable user confirmation, in which user feedback is solicited in response to an instruction to create, delete, or update an object in various scenarios. The user feedback may be used to accept or prevent an object management function. Authentication may be applied to limit user feedback to authorized users.

Link-type criteria may employ a user confirmation event to provide verification with a user, including a general user, or a special user such as an administrator during a deletion process, a creation process, or an update process. This event can be enabled or disabled. Authentication techniques may be employed to verify that a user is authorized to either enable or disable the event, or to respond to a query associated with the user confirmation event. Any authentication technique may be used. For example, user permission levels may be used to determine whether a user or a class of users has permission to provide verification. If this event is enabled, a passcode may be received and stored as part of the runtime configuration, and the passcode required for verification by a user in response to a query generated by a user confirmation event.

When deleting a DDT object, deleting its associated IDT object is not required due to the independent maintenance of IDT and DDT objects. The existing objects of link type can be searched and reused as required by a software application. This re-usability of link type objects is also considered a part of link-type criteria along with creation/deletion dependencies and other aspects described above. Example embodiments are detailed below.

A compile-time link type manager may ensure that all link type object management constructs have associated event handlers at compile time, and that such an event handler meets certain criteria for the particular link type. An example compile-time link type manager enforcing source-code defined event handlers is detailed in copending U.S. patent application Ser. No. 18/405,699 entitled “Compile-time Link Type Object Management,” filed on 5 Jan. 2024, by Sridhar Vembu et al., which is incorporated herein by reference (hereinafter the '699 application). In embodiments detailed below, an event handler in source code is not required, as the compile-time link type manager supplies the runtime object management engine automatically to manage objects at runtime. In alternate embodiments, the compile-time link type manager may use a source code event handler when one is supplied, so that event handler will be called at runtime for the particular construct and type instead of the runtime object management engine. Compile time flags or design environment settings may indicate to a compiler to use one type of compile-time link type manager, or another, or any combination thereof.

A construct in a programming language refers to a particular syntactic structure or a piece of code that performs a specific task. Constructs are the basic building blocks of a program, and they can include various elements such as data types (integers, strings, etc., as well as user-defined), variables, operators, control structures (if statements, for loops, while loops, etc.), functions and procedures, classes and objects, modules and packages, and exception handling constructs. A construct may be comprised of multiple constructs, such as a block of code. Each programming language has its own set of constructs, and the way these constructs are used can vary from one language to another.

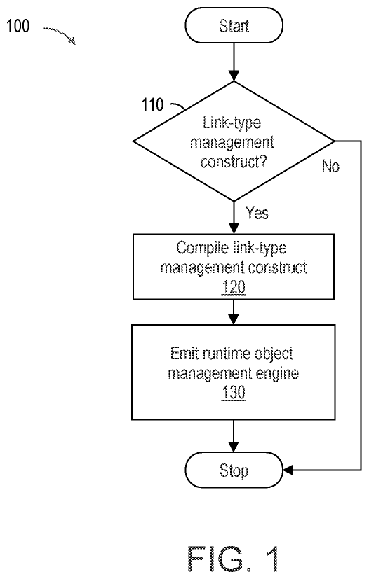

FIG. 1 is a flowchart 100 illustrating the function of a compile-time link type manager emitting a runtime management engine for a link type object management construct at compile time. Source code is evaluated for the presence of a link type object management construct (110). Compilation continues if none is found. When a link type object management construct is encountered, the link type object management construct is compiled (120). In the example embodiment, the construct is compiled into an intermediate representation (IR) and will be further processed into executable code. In addition, a runtime object management engine is emitted (130). In the example embodiment, this engine is an intrinsic function to the compiler, comprising generic object-management instructions or code, operable with the link-type management construct, and the engine code is emitted into an IR for further compilation along with the link type object management construct IR. Alternate embodiments include emitting pre-compiled executable code, or dynamic or static linking to executable code in a library. The runtime object management engine comprises generic instructions to manage linked objects at runtime, including creation, deletion, and updating of IDTs and DDTs, operable with link type object management instructions compiled from one or more link type object management constructs found in the source code. Example embodiments of runtime object management engine functions are detailed further below.

Note that it is not necessary to emit more than one copy of a runtime object management engine. In one embodiment, once a first link type object management construct is encountered in source code, the runtime object management engine is emitted, and subsequent link type object management constructs will have no further effect on the runtime object management engine. In alternate embodiments, it may be that different link type object management engines may be supported to support different subsets of link type object management constructs, and so the appropriate runtime object management engine will be emitted in response to the subset found in the source code.

In an alternative embodiment, if a Link Type Object Management (LTOM) construct is encountered, a check can be made for existence of a specific event handler for the construct and type. If the event handler is supplied it will be used for that construct and type, and compiled accordingly, as described in the aforementioned '699 application, for example. Otherwise, the runtime object management engine will be used.

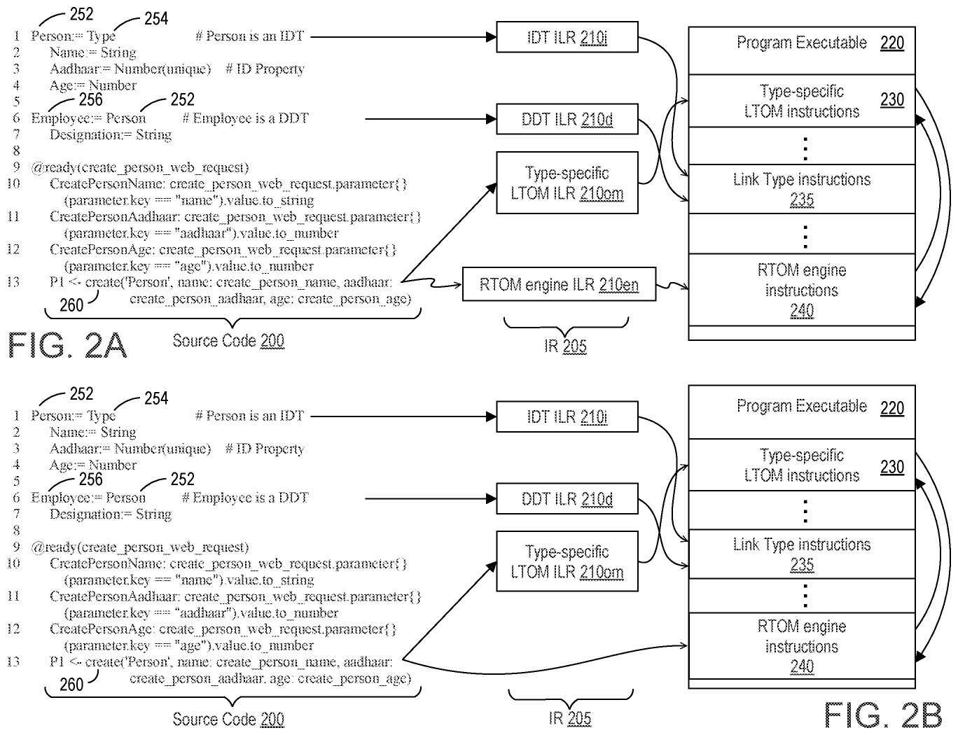

FIG. 2A illustrates how source code 200 written in accordance with one embodiment is compiled into an Intermediate Representation (IR) 205. Each data type, each link type object management construct, and a runtime object management engine is emitted into IR 205 for operating with link type object management constructs and data types. In the source code, “:=” denotes a type or element declaration and “:” denotes element or object usage. The use of pascal case (PascalCase) for object and element identifiers indicates a declaration and the use of snake case (snake_case) represents object and element usage. The delimiter “#” identifies comments.

Lines 1-4 of source code 200 define Person 252 as a Type 254. This is an example of an independent data type (IDT), as it is defined with the built-in construct Type. Person has property Aadhaar, which is a number, and is defined as a unique property. An Aadhaar is an identification number for people in India. A social security number (SSN) is a similar identifier in the United States. A Person also has numerical property, Age, in this example.

Lines 6-7 define Employee 256 as type Person 252. Employee 256 is an example of a Dependent-link Data Type (DDT) as it is derived from IDT Person 252. Employee and Person are linked types exemplifying role-sharing, as a person object can be instantiated, and an employee object shares the role of that person, and extends it as appropriate for the shared role. In this example, an employee has property Designation, a string which identifies an attribute for the employee.

In various examples detailed herein, the IDT Person and DDT Employee are used for illustration. While linked types are quite useful for all sorts of human related roles and activities, they are by no means limited as such. A football player object IDT may have a jersey product DDT linked with it. An automobile object IDT may have tire object DDT associated with it. A hospital room object IDT may be linked with numerous medical equipment DDT objects. The number of various possible combinations of link types is quite unlimited. Link types are exemplified by the creation and existence of a DDT type object depending on the creation and existence of the corresponding IDT type object, with the DDT object being inherently linked to the IDT object. However, an IDT object can be persistent in memory even after a corresponding DDT is deleted (unless and until the IDT object is deliberately deleted).

Lines 9-13 illustrate source code which incorporates a link type object management construct 260, which is a create statement for Person, an IDT, in this example. The source code trigger @ready compiles into instructions that are executed during runtime, where the instructions invoke an operation on reception of a web request. Lines 10-12 are used to unmarshal the parameters like the values of ‘name’, ‘aadhaar’ and ‘age’ from the web request. The operation create_person_web_request invokes the create statement for type Person in line 13 where the unmarshalled parameters (using lines 10-12) of the web request are assigned to the computed properties namely “name”, “aadhaar” and “age” respectively.

The “<-” operator, shown preceding the create construct in line 13, is used when an object is created, appended, or deleted. In one embodiment, the function construct, such as create, delete, and update appear together with the <- operator in source code, and instructions compiled therefrom invoke the object management instructions to execute the function. In an alternate embodiment, the object management construct, such as create, update, or delete, can be separated from the <- operator, and the expression associated with the function can be built separately. One such system is detailed in copending U.S. patent application entitled “Extensible Built-In Object Management,” filed on the same day as the present application, by Sridhar Vembu et al., which is incorporated herein by reference (hereinafter the 'xxx application). In both examples, it is the <- operator that invokes the object management instructions at runtime. As detailed further below, when an event handler is defined for the object management construct, then that event handler will be invoked prior to the object management instructions at runtime.

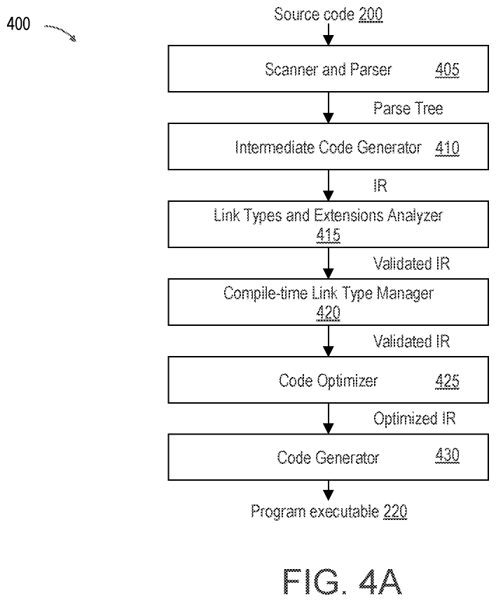

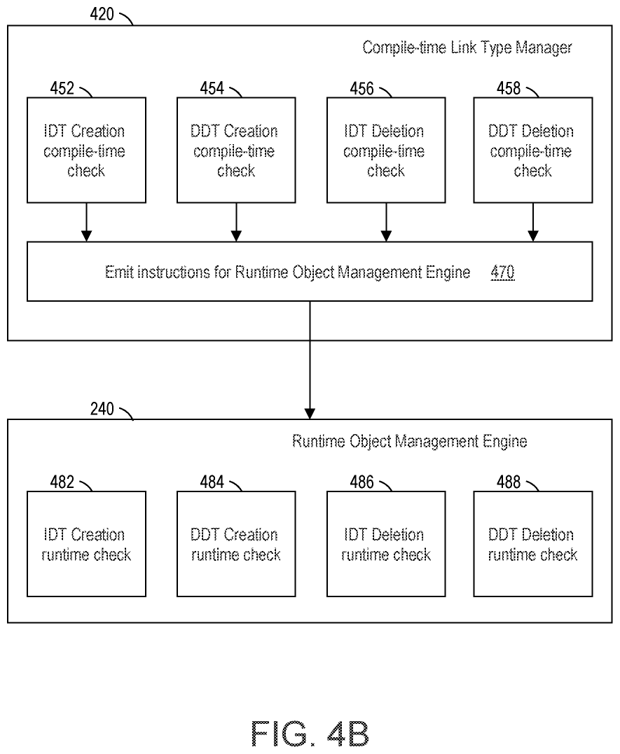

Consider the function of a compile-time link type manager as illustrated in flowchart 100 applied to the example source code 200 in FIG. 2A. In other compile functions (detailed below with respect to FIG. 4A), the independent data type Person 252 is compiled into an IDT Intermediate-Language Representation (ILR) 210i. Similarly, the dependent-link data type Employee is compiled into DDT ILR 210d. Thus, the compiler already knows the link types within source code 200.

At runtime, object management functions will be executed to affect objects in two parts. First, a general-purpose runtime engine is emitted, which is preconfigured with generic object management functions to manage and affect objects at runtime. The generic management functions in the runtime engine are accessed at runtime by type-specific instructions. The object management functions are preconfigured to operate according to the needs of the object types they are accessed to manage. Built-in management functions included in a runtime engine may be extensible as well, as detailed in the aforementioned 'xxx application. In the example embodiment, the runtime engine is preconfigured with, among others potentially for other types, management functions tailored for use with linked objects. The runtime engine can be optimally designed for its intended purpose, with generic functions, instructions, or code functional with specific types, and those optimizations are then shared among the various types when accessed by a variety of type-specific instructions (LTOM in this example). When the compile-time link type manager encounters (110) the create construct statement 260 in line 13, it proceeds to compile (120) the link type object management construct 260 into type-specific LTOM ILR 210om. Encountering the create construct also leads the compiler to emit code (130) for a runtime object management engine, in this case into RTOM engine ILR 210en.

Intermediate representation (IR) 205 comprising ILRs 210 and any other compiled source code is further compiled, as necessary, to produce program executable 220. Program executable may be stored in memory, in a file (locally stored on a hard drive, or online in the cloud), or using any other method well known to those of skill in the art. LTOM ILR 210om is compiled to form machine executable instructions illustrated as type-specific LTOM instructions 230. RTOM Engine ILR 210en is compiled to form machine executable instructions illustrated as RTOM engine instructions 240. RTOM engine ILR 210en and RTOM engine instructions 240 comprises generic object-management instructions operable with the type-specific LTOM instructions 230. For clarity, depending on the context, the term RTOM engine (for element 240) is used interchangeably with the term RTOM engine instructions, or alternatively generic object-management instructions. The link type ILRs 210i and 210d are compiled to form link type instructions 235. The illustration of locations within program executable 220 is symbolic for illustration purposes only. The instructions may be non-contiguous, in any order, and may be combined and/or shared with other executable functions derived from source code 200.

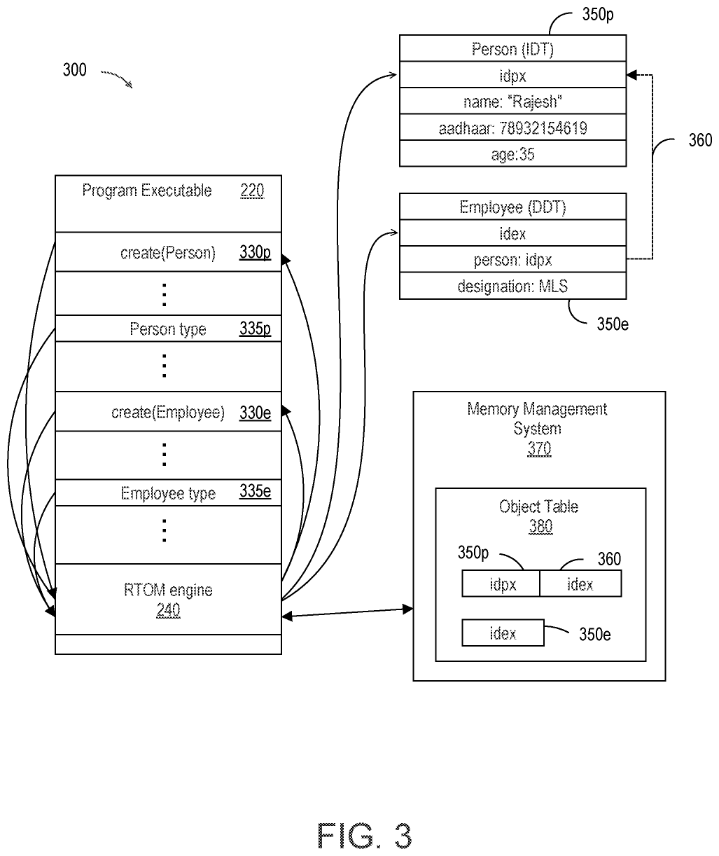

Note that type-specific LTOM instructions 230 are shown linked to RTOM engine instructions 240, as a call to a type-specific link type object management instruction will necessitate a call to access RTOM engine instructions to affect the object, subject to verifying link-type criteria. Other instructions for interacting with a memory management system will be incorporated in program executable 220 as well, in an embodiment, detailed in FIG. 3.

A runtime object management engine performs a variety of object management functions, such as create, delete, or update, for each link type, such as IDT, DDT, or types which operate as both IDT and DDT. The nomenclature delineating IDT and DDT is a convention. A type can be an IDT only, a DDT only, or it may be both. The compiler will know these linked relationships at compile time. If a type is both, it will be referred to as an IDT to its respective DDTs, even though that IDT/DDT type also has at least one IDT to which it is dependent.

In an alternate embodiment, FIG. 2B illustrates how source code 200 is compiled into an Intermediate Representation (IR) 205 with an Intermediate-Language Representation (ILR) 210 for each data type and each type-specific link type object management construct, while runtime object management engine instructions 240 are emitted into program executable 220, for operating with type-specific LTOM instructions 230 for link type objects (link type instructions 235) at runtime. This embodiment is similar to that depicted in FIG. 2A, except that instead of emitting code (130) into an IR 210en, the runtime object management engine instructions 240 are emitted in executable form directly into program executable 220. One advantage for emitting executable code is to avoid the need to repeat compilation of the RTOM engine instructions. Another is that resources expended that optimize or improve the RTOM engine instructions beyond what may otherwise occur during compiling and optimization (including, e.g., processor-specific features) are shared with all developers utilizing the compiler.

FIG. 3 illustrates a run-time environment in which a computer (not shown) having a memory 300 is loaded with executable programs, in this example, program executable 220 and memory management system 370, which, among other desired functionality of program executable 220, facilitate object management. Note that memory management system 370 is shown discretely for illustrative purposes only. It, along with other instructions described herein, are collectively part of the executable code and may be combined in various embodiments. This example illustrates the creation of two linked objects, a Person (IDT) and an Employee (DDT).

Program executable 220 comprises machine code compiled from source code 200 and IR 205, as detailed above. Instructions to create an object of type Person, create(Person) 330p, are invoked by a runtime create request. The request, an example of a type-specific link type object management instruction 230, invokes the RTOM engine 240, to execute the create instruction if runtime conditions allow.

RTOM engine 240 communicates with memory management system 370 to determine if the Person object already exists. Memory management maintains an object table 380, which contains (among other possible data) a list of existing objects and a list of dependencies for each object. Objects in the object table 380 may be identified by their type. They also may be associated with a unique identifier, such as Aadhaar, or SSN, as described above. When a user-defined unique identifier is not used, each object in a runtime environment will typically have a system-generated unique identifier, which may be used for identifying existence of an object, whether that identifier is made available from the runtime system, or if a function or procedure is available to access the information from the memory management system 370. Any number of alternate schemes may be deployed in alternate embodiments.

In this example, a request to create a person (after the unmarshalling process) named Rajesh with Aadhaar 78932154619 was issued. Assume, for the moment, that a request to memory management system 370 from RTOM engine 240 regarding existence of a person with that Aadhaar number returned false, as the object table 380 did not contain such an object. This is one example of link-type criteria being satisfied. Therefore RTOM engine 240 creates the Person object 350p for Rajesh, using instructions compiled for the Person type 335p. Memory is allocated, identified by system-generated memory location idpx (a hypothetical label for an actual machine-readable memory location), and the object identifier idpx is stored in object table 380 for object 350p. Person (IDT) 350p is created in memory at the system generated location idpx, with properties name: “Rajesh”, aadhaar: 78932154619, and age: 35. The Person type will have been known to be a link type during compile time. In this case it is an IDT, which means it may have one or more DDTs associated with it. There are no dependent objects at the moment in this example, but the memory management system will have a scheme for associating dependent objects to the independent object as they are generated. In this example, a list of dependent objects is maintained for each object type Person.

Now assume that a request to create an employee object associated with the person Rajesh is made during runtime. This is an example of a DDT create instruction. Create(Employee) instructions 330e are invoked, which in turn invokes the RTOM engine 240, to execute the DDT create instruction if runtime conditions allow. There are various procedures that can be employed in various embodiments for creating a DDT. In this example, RTOM engine 240 interfaces with memory management system 370 to determine if the IDT for linking with the DDT identified in the create instruction exists. In this example, it does, so RTOM engine 240 creates linked object Employee 350c, a DDT dependent on Person 350p. Memory management system 370 provides a system generated memory location idex (a hypothetical label for an actual machine-readable memory location) for object Employee 350c, and program executable 220 populates that object with the property designation: MLS, and a dependent link 360, the location idpx, identifying the Person object linked with this Employee object. Object table 380 will be updated to include object 350e in the list of objects. Dependent link 360 will be associated with object 350p as one of its dependencies.

Examples illustrating additional link type object management, such as delete IDT and delete DDT, are detailed further below. Such instructions reside similarly in program executable 220, and RTOM engine 240 will interface with memory management system 370 to delete objects and deallocate memory, accordingly, while maintaining object table 380 for each object.

The layout of memory 300 is illustrative only. Executable code can be loaded in any portion of memory, contiguously or otherwise, in similar order to the stored executable, or rearranged, or in any other configuration. The same is true for objects and other runtime data. It is common practice for instructions to be stored in a stack, and object data to be stored in a heap, but any memory management technique may be employed.

### Overview of Compiler

A compiler is a program that translates source code instructions for performing computational functions into machine code that can be executed by a computer, alternatively referred to as binaries, executable code, execution code, application code, etc. Some languages are not compiled but are rather interpreted. Interpretation differs from compilation in that the interpreter executes programs directly from source code without producing a standalone executable. The following discussion focuses on compilers, but those of skill in the art will recognize compiling source code to an executable that is run on a computer can be substituted with a process of interpreting the source code while running on an interpreter.

Source code is typically written in a high-level programming language, which is designed to be easy to read and understand by developers. Intermediate representations and machine code are written in more compact and efficient lower-level languages. An intermediate representation generated from one form of source code can itself be a form of source code. The methods detailed herein can be applied to original source code or various levels of source code derived therefrom. A keyword from one form of source code may be transformed to or represented by a different keyword, numerical value, or token when processed into another form of source code or intermediate representation. A reference to a particular keyword in the methods, systems and devices described herein applies equally to any transformation or alternate representation.

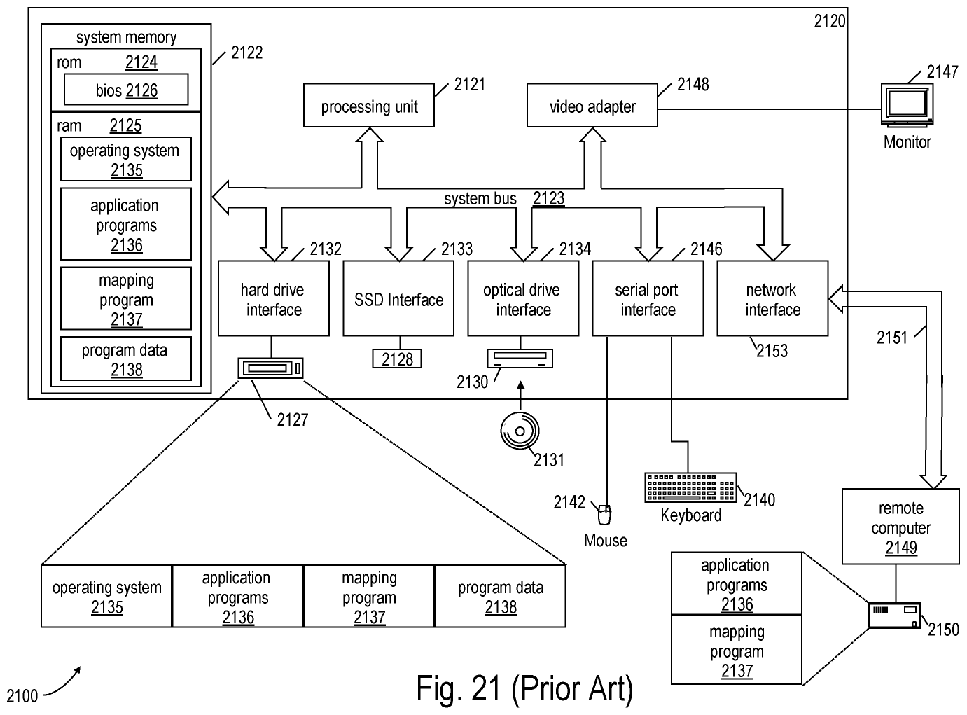

Program execution generally takes place on computer hardware in a runtime environment. The computer hardware comprises processors, memory, and storage. The runtime environment is a set of software tools and resources that runs on the computer hardware to execute a program. The runtime environment includes the operating system, libraries, and other components that are necessary for the program to run. Computer hardware and runtime environments are well known to those of skill in the art, and an example of a prior art computer is detailed below in FIG. 21.

FIG. 4A is a flowchart 400 illustrating how a compiler passes through several phases to convert source code written in a high-level language into machine code, including enforcing rules for managing link types at compile time. Initially, the compiler scans and parses (405) the source code to generate a parse tree. The generated parse tree is then fed to an intermediate code generator (410) from which an Intermediate Representation (IR) of the source code is obtained.

Link types and extensions analyzer 415 operates on the IR to semantically validate link types, IDTs, DDTs, and extensions. Example embodiments are detailed in the '035 Vembu application incorporated by reference above. The result is a validated IR. As a result of this processing, the compiler has validated link types, identified which are IDTs, which are DDTs, and which are both.

This validated IR is further processed by Compile-time Link type manager (CT-LTM) 420 which performs functions as detailed with respect to FIG. 1, above. Other embodiments may employ different or additional compiler phases processing the validated IR for other purposes. The validated IR serves as an input to the code optimization phase (425) from which the optimized IR is obtained. A code generator (430) then creates a program executable 220, specific to a target processor.

FIG. 4B depicts compile-time link type manager 420 of FIG. 4A in accordance with one embodiment. Link type object management constructs for link types are supported. Compile-time link type manager 420 includes IDT creation compile-time check (452), DDT creation compile-time check (454), IDT deletion compile-time check (456), and DDT deletion compile-time check (458). Example embodiments for each compile-time check are detailed below.

For each construct, compile-time link type manager 420 emits instructions (470) for the runtime object management engine. There can be dependencies associated with the order of creation or deletion of IDT/DDT objects, as well as user-defined constraints, and these dependencies and constraints, collectively link-type criteria, should be satisfied before creation, updating, or deletion. In this example, runtime object management engine 240 will include IDT creation runtime check (482), DDT creation runtime check (484), IDT deletion runtime check (486), and DDT deletion runtime check (488). Example embodiments for each runtime check are detailed below.

In the embodiments described below, as detailed above, at compile time, if the RTOM engine 240 code is already emitted, it does not need to be repeated. In alternative embodiments, the components of RTOM engine 240 could provide alternate functionality. For example, existence of an event handler in source code for a type and construct may override the RTOM engine for the construct and type instruction. Other functions may be enabled in concert with or as alternate to the RTOM engine code emission, in response to compile-time flags, compiler settings, system settings, or other means for selecting alternate compilation techniques. Output messages are all optional. They can be delivered to a user terminal, a log file, or any number of message techniques well known in the art.

### IDT Creation

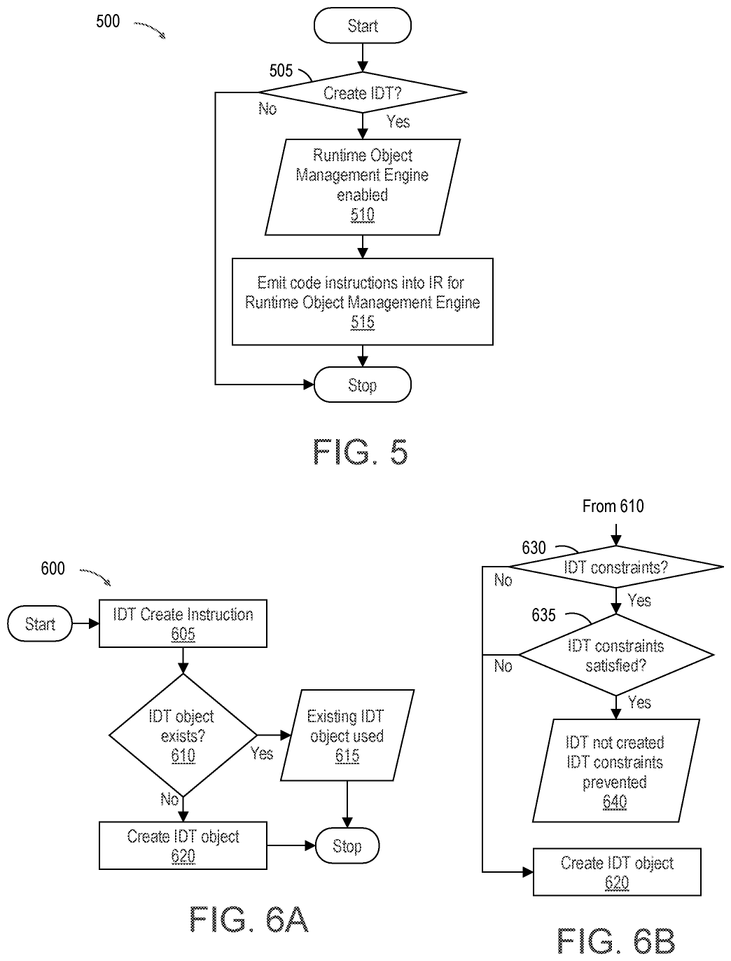

When a create statement is recognized by the compiler for an IDT type, as identified by the Link Types and Extensions Analyzer 415, the CT-LTM 420 invokes the IDT Creation-CTC 452. FIG. 5 is a flowchart 500 illustrating functions of IDT creation compile-time check 452 of FIG. 4B. Source code is evaluated for the presence of a create IDT construct (505). Compilation continues if none is found. When a create IDT construct is encountered, a message is generated (510) indicating that the runtime object management engine is enabled. The IDT Creation-CTC emits code instructions into IR for the runtime object management engine (515). Then this process terminates, and compilation continues as necessary.

FIG. 6A is a flowchart 600 illustrating functions of IDT creation runtime check 482 of FIG. 4B in one embodiment. When an IDT create instruction is received at runtime (605), the RTOM engine 240 checks for the existence of the IDT object (610). In this embodiment, RTOM engine 240 communicates with memory management system 370 to determine if an entry in object table 380 contains a pointer to the object. If the IDT object exists, a message is generated to indicate that an existing IDT object will be used (615). In this case, no object is created. If the IDT object does not exist, RTOM engine 240 creates it (620). Then execution continues.

In general, the process of returning or referencing an object in response to a construction or creation instruction depends on the programming language and the memory management model it uses. For example, in C++, if it is created on the stack, no pointer is returned, and the object exists in the scope where it was declared. A destructor is called automatically when it goes out of scope. If an object is created on the heap, a pointer to the object is returned. The programmer is responsible for managing the memory, including deleting the object when it is no longer needed. In Java, C#, Python, Ruby, and others, objects are created on the heap, and a reference to the object is returned. Memory management is handled by a garbage collector. In the example embodiment, objects in source code are referenced by their names, and object access is managed automatically in the runtime environment with memory manager 370. Thus, whether a new IDT is created or an existing one is used, the create instruction will succeed and the object will be available for further execution, unless an error or exception occurs. Any memory management technique can be deployed in various embodiments.

The embodiment of FIG. 6A is a general embodiment with basic functionality for creating an IDT and identifying link-type criteria including existence of the IDT in the create instruction. Any combination of link-type criteria may be used, including IDT existence, updating of the IDT, user confirmation event enabled, user response, and so forth. Additionally, user-defined constraints for IDT creation may be defined. For example, an IDT constraint may be included to place a cap on the number of a certain class of IDTs, and the constraint will prevent creation when the cap is reached. Any combination of these could be employed in various embodiments. Examples illustrating some of these aspects are detailed below.

FIG. 6B illustrates a modification to flowchart 600 to include IDT creation constraints. Here, the following additional steps are included prior to creating IDT object (620). RTOM engine 240 determines whether IDT create constraints exist (630), which may be user-defined or intrinsic, that, if satisfied, would preclude the IDT object from being created. If the constraints exist, and are satisfied (635), then a message is generated indicating that the IDT object is not created, as IDT constraints prevented creation (640). If the constraints do not exist, or are not satisfied, the IDT object is created (620). Then execution continues.

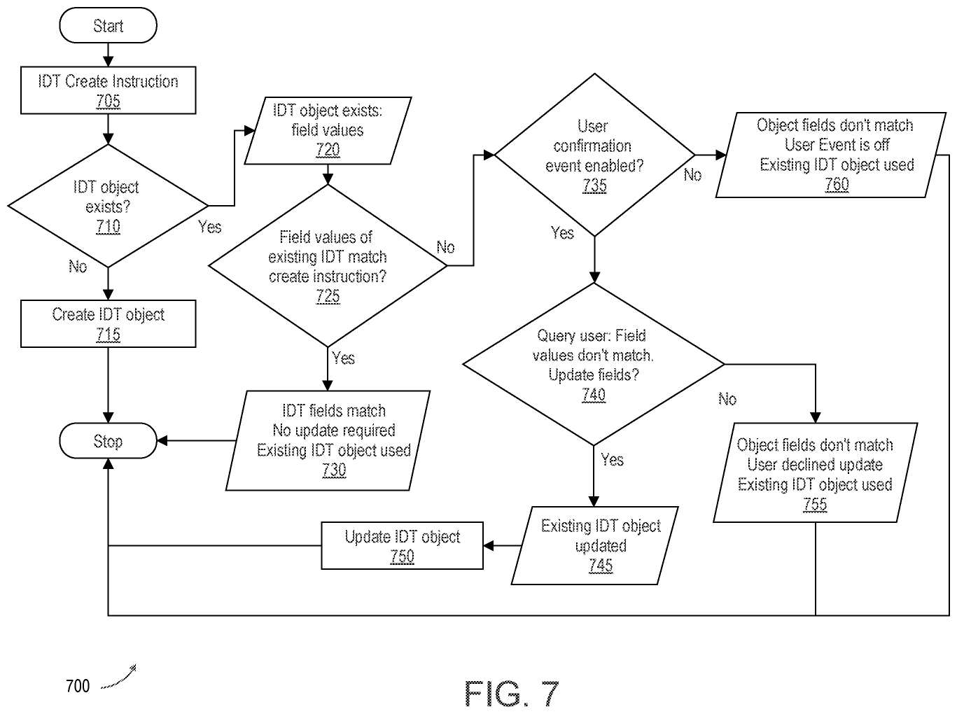

FIG. 7 is a flowchart 700 illustrating functions of IDT creation runtime check 482 of FIG. 4B in an alternate embodiment. This example highlights several additional link-type criteria for IDT creation. In one aspect, field values for an existing IDT object are compared with field values in an IDT create instruction. There are a variety of design choices for responding to that comparison. In one embodiment, the object can be simply updated with the latest field values. However, that may not be the desired functionality. In another aspect, a user confirmation event can be specified where a user is queried for a response on how to handle various link type object management scenarios. The user confirmation event can be conditionally applied, responsive to a setting, such as supplied as a compile-time flag, or in runtime settings, or other techniques. In this embodiment, when the comparison shows a difference, and the user confirmation event is enabled, then the user is queried to update the IDT object with the fields from the create instruction or to reject those fields and keep the existing IDT object as it is.

When an IDT create instruction is received at runtime (705), the RTOM engine 240 checks for the existence of the IDT object (710). If the IDT object does not exist, RTOM engine 240 creates it (715). The create IDT object (715) can be modified to include IDT creation constraints as detailed in FIG. 6B. Then execution continues.

If the IDT object exists (710), a message is generated indicating that the IDT object exists, and the IDT's field values are listed (720). If the field values of the existing IDT match the field values in the IDT create instruction (725), then a message is generated indicating that no update is required, and the existing IDT object is used. In this case, no IDT needs to be created, and, since the fields match, there is no need for an update to the IDT object. A message (730) stating this is generated. Then execution continues.

If the field values are not the same (725), it may be desirable to update the IDT object with the values in the create IDT instruction. For example, consider a person (with a unique identifier element, such as Aadhaar or SSN) whose mobile number has changed between the original instantiation of the respective Person IDT and a current create instruction. In the original object creation, the mobile number was 99988 87776, associated with Aadhaar ARIPS0033456. Here, the runtime process is processing a create IDT instruction for that same Aadhaar (which it has already noticed exists, so no duplicated IDT has been created) and will recognize the mobile number element supplied in the pending create instruction has changed to 88899 97776. As mentioned previously, one design choice is to simply update the mobile number for that Person object.

In this embodiment, if the user confirmation event is enabled (735), then the user is informed the fields don't match, and queried whether to update the fields (740). If the user responds affirmatively, a message is generated indicating the existing IDT object will be updated (745), and the IDT object is in fact updated (750). Then execution continues. In one embodiment, an authorization procedure may be employed to verify the user responding to the query is authorized to make the change, for example, using a passcode such as described above.

If the user query response is negative (740), then the existing IDT object will not be updated. A message is generated indicating that the IDT fields don't match, the user declined to update, so the existing IDT object will be used (755). Then execution continues.

If the user confirmation event is disabled (735), then a message is generated indicating that the IDT object fields don't match, and that since user confirmation is disabled, no update will occur, and the existing IDT object will be used (760). The message may contain a warning that the user confirmation event should be enabled to allow for updating. Then execution continues. This is one design choice, which is to default to no update when fields differ, and user confirmation is disabled. In an alternate embodiment, if user confirmation is off, and the fields differ (735), an alternate default could be to update the IDT object and generate an alternate message so indicating, with a corresponding warning regarding the default if desired (details not shown).

### DDT Creation

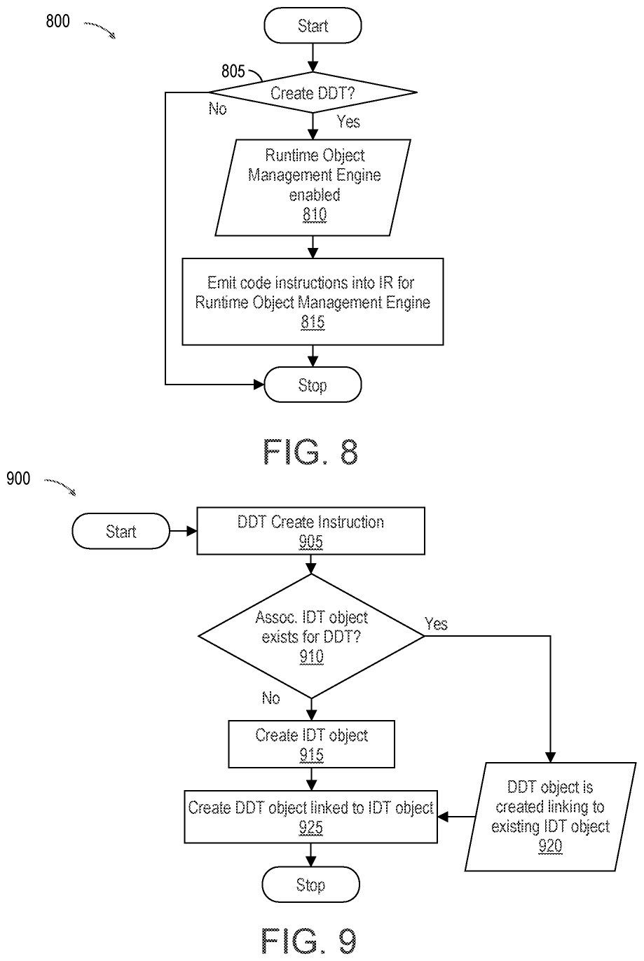

When a create statement is recognized by the compiler for a DDT type, as identified by the Link Types and Extensions Analyzer 415, the CT-LTM 420 invokes the DDT Creation-CTC 454. FIG. 8 is a flowchart 800 illustrating functions of DDT creation compile-time check 454 of FIG. 4B. Source code is evaluated for the presence of a create DDT construct (805). Compilation continues if none is found. When a create DDT construct is encountered, a message is generated (810) indicating that the runtime object management engine is enabled. The DDT Creation-CTC emits code instructions into IR for the runtime object management engine (815). Then this process terminates, and compilation continues as necessary. As detailed above, if the RTOM engine code is already emitted, it does not need to be repeated. In alternative embodiments, DDT Creation-CTC could provide alternate functionality. For example, existence of an event handler in source code may override the RTOM engine for the construct and type instruction. Other functions may be enabled in concert with or as alternate to the RTOM engine code emission, in response to compile-time flags, compiler settings, system settings, or other means for selecting alternate compilation techniques. Output messages are all optional. They can be delivered to a user terminal, a log file, or any number of message techniques well known in the art.

FIG. 9 is a flowchart 900 illustrating functions of DDT creation runtime check 484 of FIG. 4B in one embodiment. When a DDT create instruction is received at runtime (905), the RTOM engine 240 checks for the existence of the IDT object associated with the DDT object to be created (910), using similar techniques as detailed above with respect to IDT creation. If the associated IDT object exists, a message is generated to indicate that the DDT object will be created and linked to an existing IDT object (920). If the associated IDT object does not exist (910), RTOM engine 240 creates it (915). The create IDT object (915) can be modified to include IDT creation constraints as detailed in FIG. 6B. In either case, the DDT object is created (925) and linked to the associated IDT (which may have been preexisting or newly created). Then execution continues.

The embodiment of FIG. 9 is a general embodiment with basic functionality for creating a DDT and identifying link-type criteria including existence of an associated IDT. Any combination of link-type criteria may be used, including IDT existence, updating of the IDT, user confirmation event enabled, user response, and so forth. Additionally, user-defined constraints for DDT creation may be defined. For example, a DDT constraint may be included to prevent adding an employee to a team where the maximum capacity has been reached. These criteria may be evaluated at runtime and the DDT creation and linking (925) may be subject to satisfaction of the criteria (details not shown). Examples illustrating some of these aspects are detailed below.

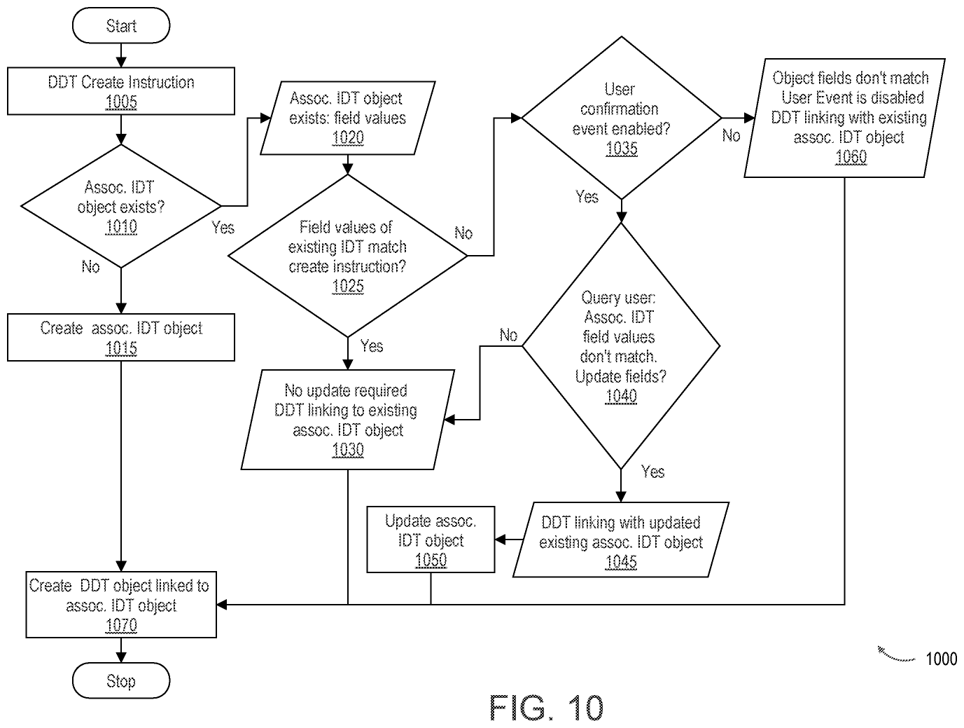

FIG. 10 is a flowchart 1000 illustrating functions of DDT creation runtime check 484 of FIG. 4B in an alternate embodiment. This example highlights several of the additional link-type criteria for DDT creation. In one aspect, field values for an existing associated IDT object are compared with field values in a DDT create instruction. As detailed above with respect to IDT creation, there a variety of design choices for responding to that comparison. In one embodiment, the object can be simply updated with the latest field values. However, that may not be the desired functionality. In another aspect, a user confirmation event can be specified where a user is queried for a response on how to handle various link type object management scenarios. The user confirmation event can be conditionally applied, responsive to a setting, such as supplied as a compile-time flag, or in runtime settings, or other techniques. In this embodiment, when the comparison shows a difference, and the user confirmation event is enabled, then the user is queried to update the IDT object with the fields from the create instruction or to reject those fields and keep the existing IDT object as it is.

When a DDT create instruction is received at runtime (1005), the RTOM engine 240 checks for the existence of the associated IDT object (1010). If the IDT object does not exist, RTOM engine 240 creates it (1015). The create IDT object (1015) can be modified to include IDT creation constraints as detailed in FIG. 6B. The DDT object is created and linked to the associated IDT object (1070), newly created in this instance. Then execution continues.

If the IDT object exists (1010), a message is generated indicating that the associated IDT object exists, and the IDT's field values are listed (1020). If the field values of the existing associated IDT match the field values in the DDT create instruction (1025), then there is no need to create a new IDT, and neither is there a need to update the existing IDT. A message is generated indicating that no update is required, and the DDT object will be created linking to the existing associated IDT object (1030). The DDT object is created and linked to the associated IDT object (1070), already existing in this instance. As with flowchart 900, DDT creation criteria may be evaluated at runtime and the DDT creation and linking (925) may be subject to satisfaction of the criteria (details not shown). Then execution continues.

If the field values are not the same (1025), it may be desirable to update the associated IDT object with the values in the create DDT instruction. One example scenario was detailed above with respect to IDT creation. In this embodiment, if the user confirmation event is enabled (1035), then the user is informed that the associated IDT fields don't match and queried whether to update the fields (1040). If the user responds affirmatively, a message is generated indicating the DDT will be created and linked to the existing IDT object as updated (1045), and the associated IDT object is in fact updated (1050). The DDT object is created and linked to the associated IDT object (1070), already existing, and updated, in this instance. Then execution continues. In one embodiment, an authorization procedure may be employed to verify the user responding to the query is authorized to make the change, for example, using a passcode such as described above.

If the user query response is negative (1040), then the existing associated IDT object will not be updated. The message indicating that no update is required, and the DDT object will be created linking to the existing associated IDT object is generated (1030). The DDT object is created and linked to the associated IDT object (1070), already existing, and not updated in this instance. Then execution continues.

If the user confirmation event is disabled (1035), then a message is generated indicating that the associated IDT object fields don't match, and that since user confirmation is disabled, no update will occur and the existing associated IDT object will be used (1060). The message may contain a warning that the user confirmation event should be enabled to allow for updating. The DDT object is created and linked to the associated IDT object (1070), already existing and not updated in this instance. Then execution continues. This is one design choice, which is to default to no update when fields differ and user confirmation is disabled. In an alternate embodiment, if user confirmation is off, and the fields differ (1035), an alternate default could be to update the IDT object and generate an alternate message so indicating, with a corresponding warning regarding the default if desired (details not shown).

In some instances, it is possible that certain DDTs may be unique to an IDT, and that can also be evaluated as a link-type criteria prior to DDT creation. In one example, there may be a unique identifier for a DDT such that there is a single DDT for an IDT. Alternately, multiple DDTs for an IDT may be possible, but limited by context. For example, it may be desirable for multiple employee objects to link with a single person, when that person has multiple jobs. However, it may make sense to limit the number of employee objects to a single employee object for a person for a particular company. In either case, the existence of a DDT of a type, or a DDT of a type for the defined context, can be evaluated and the DDT creation or deletion may be affected thereby. Evaluating a create instruction for an existing DDT object, like described above with respect to IDT creation, allows for a choice to update or not based on such criteria, as well as comparing existing and new values, or user input. These examples uses and others will be readily adapted by those of skill in the art.

### IDT Deletion

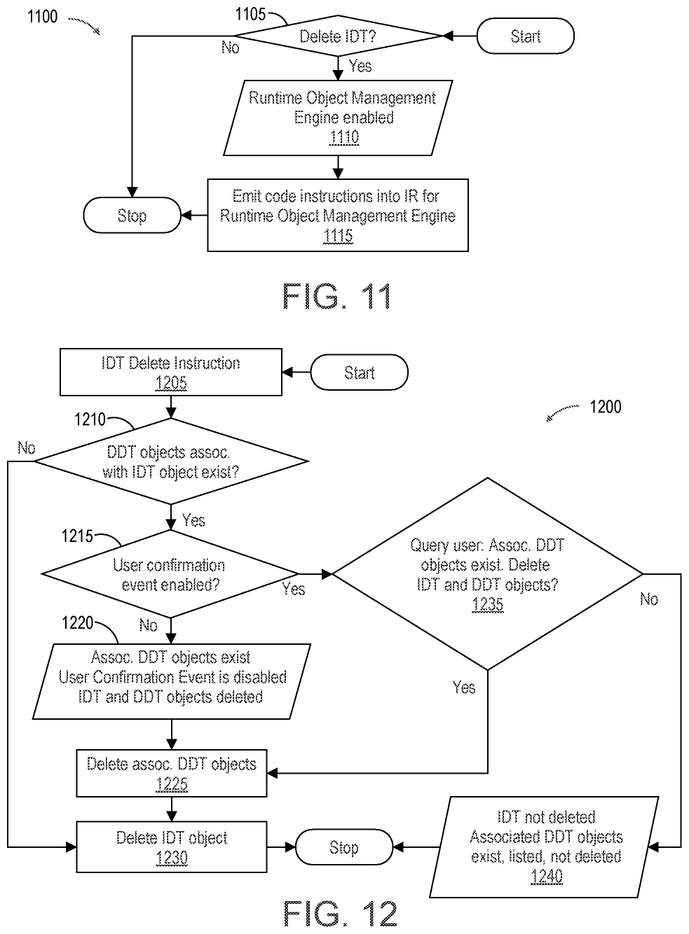

When a delete statement is recognized by the compiler for an IDT type, as identified by the Link Types and Extensions Analyzer 415, the CT-LTM 420 invokes the IDT Deletion-CTC 456. FIG. 11 is a flowchart 1100 illustrating functions of IDT deletion compile-time check 456 of FIG. 4B. Source code is evaluated for the presence of a delete IDT construct (1105). Compilation continues if none is found. When a delete IDT construct is encountered, a message is generated (1110) indicating that the runtime object management engine is enabled. The IDT Deletion-CTC emits code instructions into IR for the runtime object management engine (1115). Then this process terminates, and compilation continues as necessary.

IDT and DDT objects are maintained independently with unique system-generated IDs, regardless of how they were created. Due to this independent maintenance of objects, the deletion of DDT and IDT objects are performed in a distinct way. An IDT type may also include an IDT element (IDTE) that represents a collection of objects. In the example embodiment, aspects described herein provide for creation and deletion of IDT and DDT objects to avoid duplication of IDTs being created and to prevent “orphan” DDTs when deleting IDTs. These techniques avoid the need for memory garbage collection when these techniques are followed.

When a DDT object is deleted, its corresponding IDT object is retained, which can be used in the future, as necessary. In one example of IDT object deletion, all its associated DDT and IDTE objects are deleted by default. This automatic cascaded deletion of associated DDT and IDTE objects may not be favorable in some situations and may be unexpected behavior to some developers. In an alternative embodiment, controls are provided to handle the deletion of IDT objects, including various link-type criteria described above, including establishing user-defined constraints for deletion.

There are a variety of options for an IDT deletion runtime check 486 as part of RTOM engine 240. When an IDT object exists without any dependent DDT objects, nor any other dependencies, then the decision to delete the IDT object is not complicated. However, when a request to delete an IDT object with dependent DDT objects is made, RTOM engine 240 needs a delete strategy for those DDTs, as well as any other dependencies of the IDT. Example delete strategies include generating an error rather than deleting, automatically deleting DDTs and dependencies as just described, or deleting DDTs conditionally, based on constraints. The RTOM engine 240 can have one or more strategies prescribed for various types. These strategies can be optionally overridden by a special purpose event handler in source code, in an alternative embodiment.

FIG. 12 is a flowchart 1200 illustrating functions of IDT deletion runtime check 486 of FIG. 4B in one embodiment. When an IDT delete instruction is received at runtime (1205), the RTOM engine 240 checks for the existence of any DDT objects linked with the IDT object (1210). RTOM engine 240 communicates with memory management system 370 to determine if DDT objects exist in object table 380 linked to the IDT object. If there are no dependent objects, then the IDT object is deleted (1230). Then execution continues.

If one or more DDT objects exist (1210), then it may be desirable to seek user input about whether to delete those DDT objects. If the user confirmation event is enabled (1215), then the user is informed that associated DDTs exist for the IDT and queried whether to delete those objects (1235). If the user responds affirmatively, the associated DDT objects are deleted (1225) and the IDT is deleted (1230). Then execution continues. In one embodiment, an authorization procedure may be employed to verify the user responding to the query is authorized to make the change, for example, using a passcode such as described above.

If the user query response is negative (1235), then the IDT object will not be deleted, nor will its associated DDT objects. A message is generated indicating that the IDT object and its associated DDT objects, which are listed, are not deleted (1240). Then execution continues.

If the user confirmation event is disabled (1215), then a message is generated indicating that associated DDT objects exist, and lists them, and that since the user confirmation event is disabled, the IDT and DDT objects are deleted (1220). The message may contain a warning that the user confirmation event should be enabled to allow for managing deletion or retention, if desired. The associated DDT objects are deleted (1225) and the IDT is deleted (1230). Then execution continues. This is one design choice, which is to delete the IDT and associated DDTs when user confirmation is disabled.

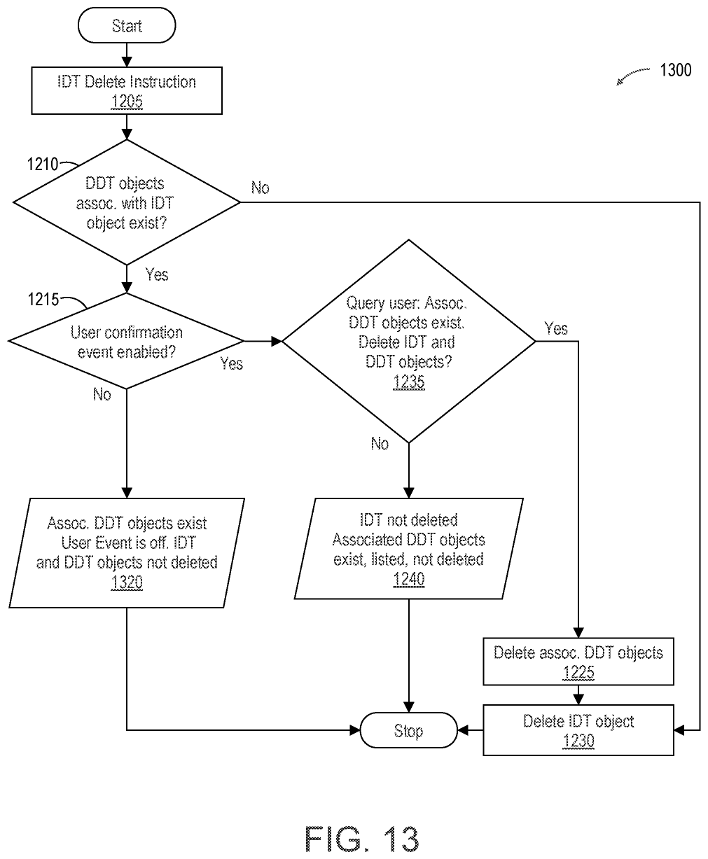

FIG. 13 is a flowchart 1300 illustrating an alternate embodiment of IDT deletion runtime check 486. Flowchart 1300 is identical to flowchart 1200, except that when the user event is disabled (1215), instead of deleting the IDT and associated DDTs, a message is generated indicating that associated DDT objects exist, and lists them, and that since the user confirmation event is disabled, the IDT and DDT objects are not deleted (1320). The message may contain a warning that the user confirmation event should be enabled to allow for managing deletion or retention, if desired. Then execution continues.

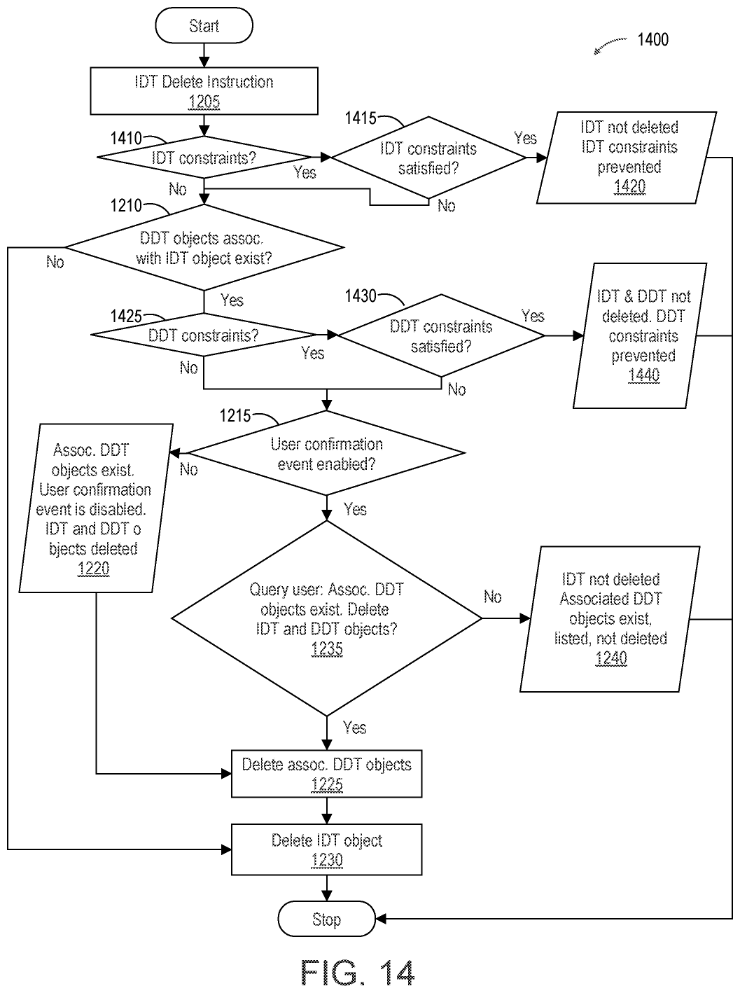

FIG. 14 is a flowchart 1400 illustrating an embodiment of IDT deletion runtime check 486 introducing constraints. Flowchart 1400 shares some steps with flowchart 1200, as identified by like numbers, but introduces IDT object deletion constraints and DDT object deletion constraints.

When an IDT delete instruction is received at runtime (1205), RTOM engine 240 determines if there are IDT constraints (1410), which may be user-defined or intrinsic, that, if satisfied, would preclude the IDT object from being deleted. If the constraints exist, and are satisfied (1415), then a message is generated indicating that the IDT object is not deleted, as IDT constraints prevented deletion (1420). Then execution continues.

If there are no IDT constraints (1410) or the IDT constraints are not satisfied (1415), then RTOM engine 240 checks for the existence of any DDT objects linked with the IDT object (1210). RTOM engine 240 communicates with memory management system 370 to determine if DDT objects exist in object table 380 linked to the IDT object. If there are no dependent objects, then the IDT object is deleted (1230). Then execution continues.

If one or more DDT objects exist (1210), RTOM engine 240 determines if there are DDT constraints (1425), which may be user-defined or intrinsic, that, if satisfied, would preclude the DDT object from being deleted. There may be constraints for one or more associated DDTs. If the constraints exist, and are satisfied (1430), then a message is generated indicating that the IDT object and any DDT objects are not deleted, as DDT constraints prevented deletion (1440). As at least one DDT was not eligible for deletion, then its associated linked IDT must also remain. Execution then continues.

If there are no DDT constraints (1425) or the DDT constraints are not satisfied (1430), then it may be desirable to seek user input about whether to delete IDT and DDT objects. If the user confirmation event is enabled (1215), then the user is informed that associated DDTs exist for the IDT and queried whether to delete those objects (1235). If the user responds affirmatively, the associated DDT objects are deleted (1225) and the IDT is deleted (1230). Then execution continues. In one embodiment, an authorization procedure may be employed to verify the user responding to the query is authorized to make the change, for example, using a passcode such as described above.

If the user query response is negative (1235), then the IDT object will not be deleted, nor will its associated DDT objects. A message is generated indicating that the IDT object and its associated DDT objects, which are listed, are not deleted (1240). Then execution continues.

If the user confirmation event is disabled (1215), then a message is generated indicating that associated DDT objects exist, and lists them, and that since the user confirmation event is disabled, the IDT and DDT objects are deleted (1220). The message may contain a warning that the user confirmation event should be enabled to allow for managing deletion or retention, if desired. The associated DDT objects are deleted (1225) and the IDT is deleted (1230). Then execution continues. This is one design choice, which is to delete the IDT and associated DDTs when user confirmation is disabled.

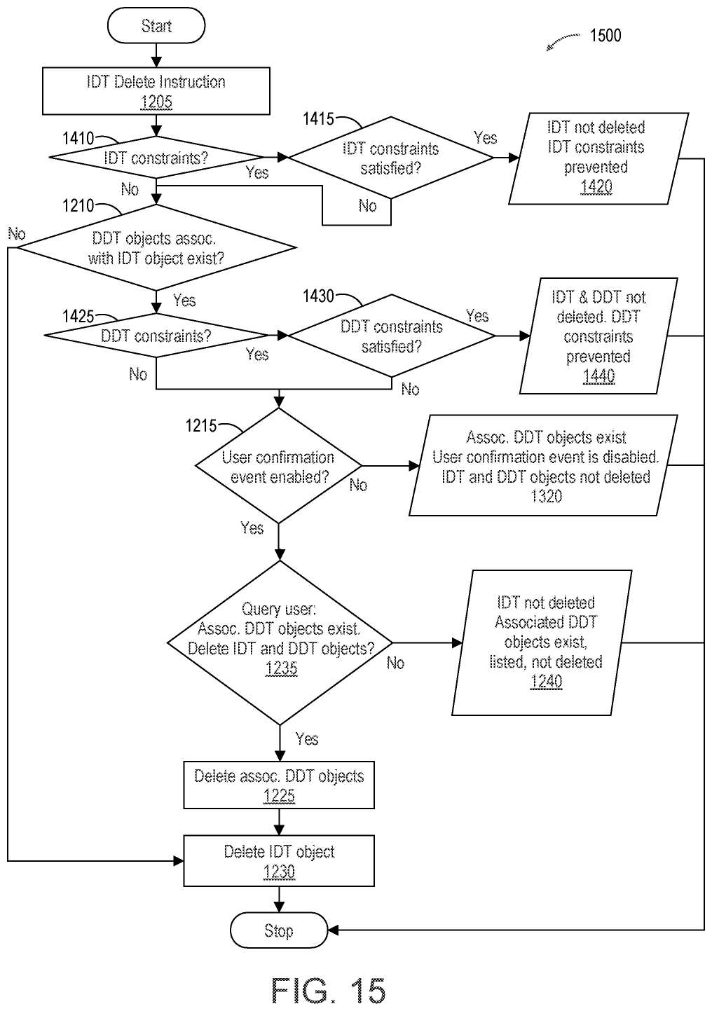

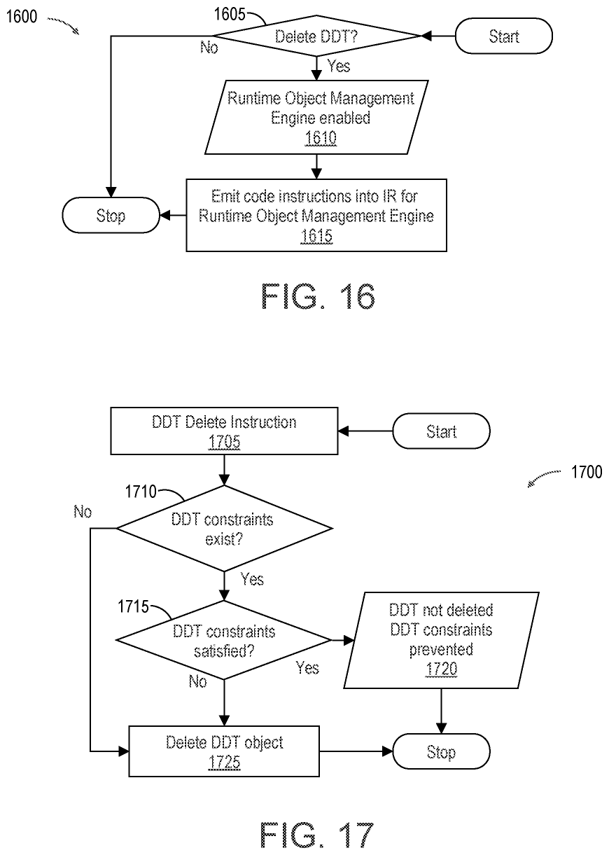

FIG. 15 is a flowchart 1500 illustrating an alternate embodiment of IDT deletion runtime check 486. Flowchart 1500 is identical to flowchart 1400, except that when the user confirmation event is disabled (1215), instead of deleting the IDT and associated DDTs, a message is generated indicating that associated DDT objects exist, and lists them, and that since the user confirmation event is disabled, the IDT and DDT objects are not deleted (1320). The message may contain a warning that the user confirmation event should be enabled to allow for managing deletion or retention, if desired. Then execution continues. Whether to use flowchart 1500 or 1400 is a design choice. One or the other may be more optimal depending on the circumstances.

### DDT Deletion

When a delete statement is recognized by the compiler for a DDT type, as identified by the Link Types and Extensions Analyzer 415, the CT-LTM 420 invokes the DDT Deletion-CTC 458. FIG. 16 is a flowchart 1600 illustrating functions of DDT deletion compile-time check 458 of FIG. 4B. Source code is evaluated for the presence of a delete DDT construct (1605). Compilation continues if none is found. When a delete DDT construct is encountered, a message is generated (1610) indicating that the runtime object management engine is enabled. The IDT Deletion-CTC emits code instructions into IR for the runtime object management engine (1615). Then this process terminates, and compilation continues as necessary.

FIG. 17 is a flowchart 1700 illustrating functions of DDT deletion runtime check 488 of FIG. 4B in one embodiment. When a DDT delete instruction is received at runtime (1705), the RTOM engine 240 determines if there are DDT constraints (1710), which may be user-defined or intrinsic, that, if satisfied, would preclude the DDT object from being deleted. If the constraints exist, and are satisfied (1715), then a message is generated indicating that the DDT object is not deleted, as DDT constraints prevented deletion (1720). Then execution continues. If there are no DDT constraints (1710) or the IDT constraints are not satisfied (1715), then the DDT object is deleted (1725), and execution continues.

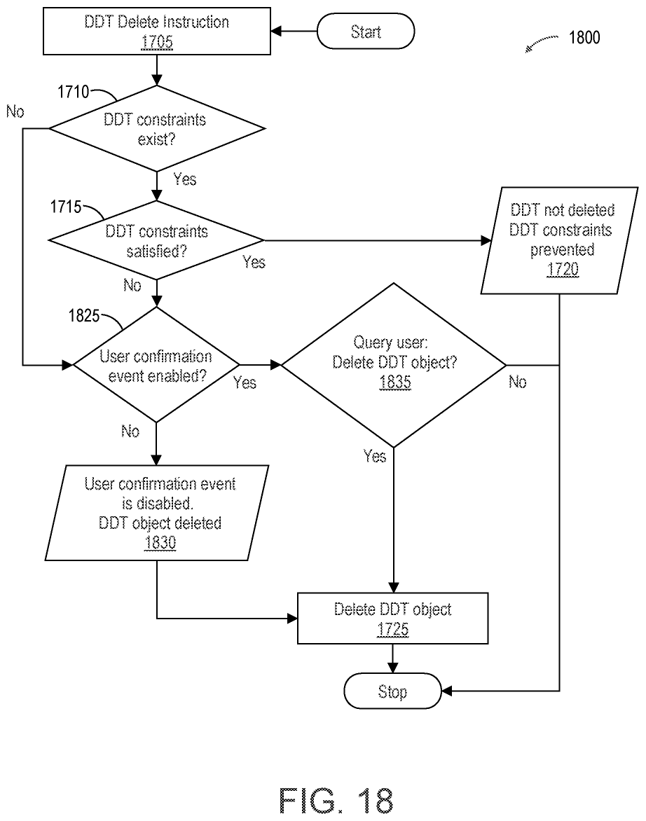

FIG. 18 is a flowchart 1800 illustrating functions of a DDT deletion runtime check 488 embodiment with user confirmation included. Flowchart 1800 shares some steps with flowchart 1700, as identified by like numbers. When a DDT delete instruction is received at runtime (1705), the RTOM engine 240 determines if there are DDT constraints (1710), which may be user-defined or intrinsic, that, if satisfied, would preclude the DDT object from being deleted. If the constraints exist, and are satisfied (1715), then a message is generated indicating that the DDT object is not deleted, as DDT constraints prevented deletion (1720). Then execution continues.

If no DDT constraints exist (1710) or they are not satisfied (1715), then it may be desirable to seek user input about whether to delete the DDT object. If the user confirmation event is enabled (1825), then the user is queried whether to delete the DDT object (1835). If the user responds affirmatively, the DDT object is deleted (1725). Then execution continues. In one embodiment, an authorization procedure may be employed to verify the user responding to the query is authorized to make the change, for example, using a passcode such as described above. If the user query response is negative (1835), then the DDT object will not be deleted, and execution continues.

If the user confirmation event is disabled (1825), then a message is generated indicating the user confirmation event is disabled, so the DDT object is deleted (1830). The message may contain a warning that the user confirmation event should be enabled to allow for managing deletion or retention, if desired. The DDT object is deleted (1725) and execution continues. This is one design choice, which is to delete the DDT when user confirmation is disabled.

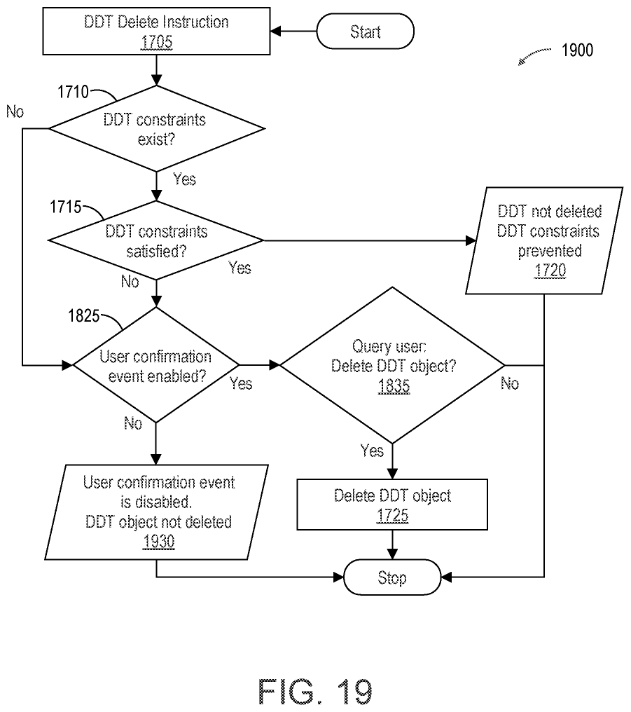

FIG. 19 is a flowchart 1900 illustrating an alternate embodiment of DDT deletion runtime check 488 with the user confirmation event. Flowchart 1900 is identical to flowchart 1800, except that when the user event is disabled (1825), instead of deleting the DDT, a message is generated indicating the user confirmation event is disabled and so the DDT object is not deleted (1930). The message may contain a warning that the user confirmation event should be enabled to allow for managing deletion or retention, if desired. Then execution continues. Whether to use flowchart 1900 or 1800 is a design choice. One or the other may be more optimal depending on the circumstances.

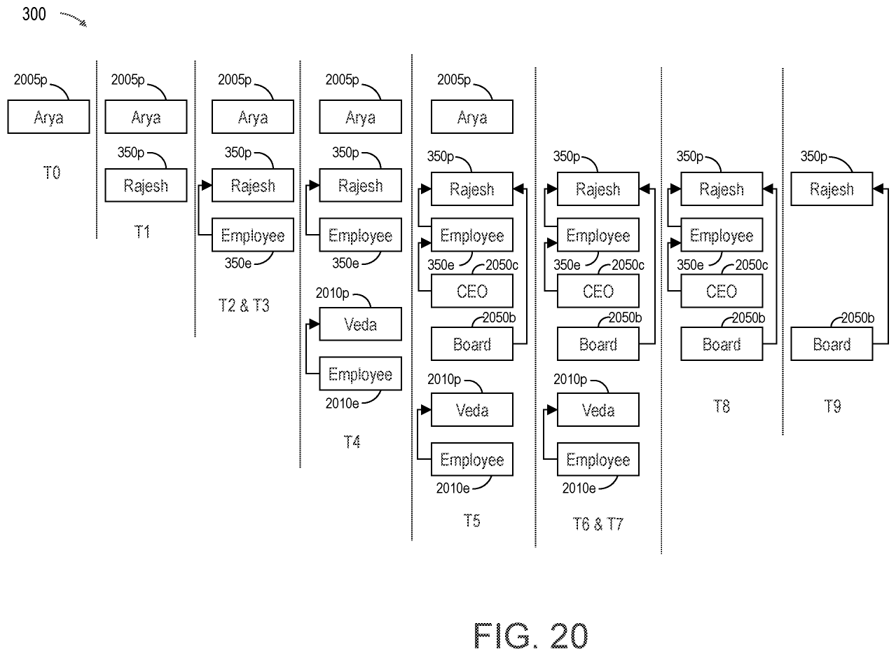

FIG. 20 illustrates a memory 300 during runtime following various example link type object management instructions, such as IDT and DDT creations and deletions. For this example, executable program 220 and memory management system 370 operate in a runtime environment to modify a memory 300 (for example, as described above with respect to FIG. 3) to instantiate and delete objects in response to illustrative runtime IDT and DDT link type object management events. Memory 300 is described using simplified representations of these IDT and DDT objects at various times identified as time periods T0-T9.

Assume for this illustration that executable program 220 has been compiled with create and delete statements for IDTs and DDTs and RTOM engine 240. Also introduced are two new DDT types (details not shown). One is a DDT type Board, which links with type Person. A second is a DDT type CEO, which links with type Employee. Therefore, in this example, an object of type employee can be both a DDT (dependent on Person) and an IDT (with respect to dependency CEO). Although any create or delete constructs could be used, assume for this illustration that the delete and create events occur in response to web requests.

At TO, memory 300 already comprises one IDT for person Arya 2005p. A create Person Rajesh is encountered. RTOM engine 240 is invoked. It checks for the existence of Person object Rajesh and finds that one does not exist. It also evaluates any other IDT creation constraints that exist, and determines there is no constraint preventing creation, so IDT object Rajesh 350p is created. The result is shown at time T1, where person objects Arya 2005p and Rajesh 350p exist.

The next link type object management event is a create Employee for Person Rajesh. The RTOM engine 240 is invoked. It checks for the existence of the associated IDT object, Person object Rajesh, and finds it. It also evaluates any other DDT creation constraints that exist, and determines there is no constraint preventing creation, so DDT object Employee 350e is created and linked to Person object 350p. The result is shown at time T2, where person objects Arya 2005p and Rajesh 350p exist, along with dependent employee object 350c.

Next, a create Person event is encountered for Arya. This is an example of an IDT create for an existing IDT. In this case, RTOM engine 240 locates the existing person object 2005p for Arya, so no new object is created. The result for T3 is shown, which is the same as at T2.

Another create Employee event is encountered, this time for Veda. This is an example of a DDT create where the associated IDT does not exist. As such, RTOM engine 240 creates the Person Veda, 2010p, and then creates linked Employee Veda 2010e. It is assumed that other IDT/DDT constraints were satisfied. The result is shown at time T4, where person objects Arya 2005p, Rajesh 350p, and Veda 2010p exist, along with dependent employee objects 350c and 2010c.

For the next illustration, Rajesh receives a promotion to CEO, which includes a position on the board of directors. There are two create DDT events, which can happen in any order. Employee 350e exists, and, while existing as a DDT for Person Rajesh, it also acts as an IDT for DDT type CEO. Had Employee object 350e not existed for Rajesh, one could have been created, as for any IDT during DDT creation. Here, it did exist, so CEO object 2050c linked to DDT/IDT object 350e is created. Second, a DDT object Board 2050b linked with Person Rajesh 350p is created. The result is shown at time T5, where person objects Arya 2005p, Rajesh 350p, and Veda 2010p exist, dependent employee objects 350e and 2010e exist, and dependent objects Board 2050b and CEO 2050c exist.

Now a delete IDT event for Arya is encountered. In this example, Arya has no dependencies, so unless there are other user-defined constraints, there is nothing to prevent the deletion of IDT Person Arya. Assume there are no other preventative constraints, so Arya person 2005p is deleted. Memory management system 370 would make the appropriate updates to the object table 380 and memory associated with the object deleted is released for reuse (details not shown). Now memory 300, at time T6, includes person objects Rajesh 350p and Veda 2010p, dependent employee objects 350e and 2010e, and dependent objects Board 2050b and CEO 2050c.

Next a delete IDT event for Veda is encountered. In this example, IDT Person object 2010p has dependent object 2010e associated with it. A variety of alternate design choices for IDT deletion are detailed above. For example, deleting any associated DDTs with an IDT delete is one option. In that case Veda person and employee would both be deleted. User-defined constraints can also be used to regulate deletion of one or more DDT objects when an IDT delete is called for. So, if constraints for a DDT allow it, a delete IDT can delete both the DDT and the IDT. Or, if at least one constraint for at least one DDT prevents DDT deletion, the IDT should remain, so as not to orphan the linked DDT. For illustration purposes, assume that in this case the RTOM engine 240 prevents the deletion of the IDT when associated DDTs exist. So, while Veda employee 2010e exists, deletion of Veda person 2010p does not occur. Thus, the result at T7 is the same as T6.

A delete DDT request for Employee Veda is then encountered. Assume there are no DDT criteria that would prevent deletion in this example. Since Employee Veda 2010c is a DDT (and is not an IDT to another type), it can be deleted, while leaving Person Veda 2010p in place and unmodified (although the dependency list in object table 380 would naturally be updated with the removal of dependency 2010c). A second delete IDT event for Veda is encountered. This time, IDT Person object 2010p has no dependent object associated with it, the employee DDT having just been removed. Barring another constraint, none existing in this example, Person object 2010p for Veda is deleted. The result is shown at time T8, where only IDT object Rajesh person 350p, DDT/IDT object Rajesh employee 350c, DDT object Rajesh employee CEO 2050c, and DDT object Rajesh Board 2050b exist.

Assume for illustration that type CEO has a user-defined constraint that allows it to be deleted whenever its linked object employee is deleted. Then when a delete DDT request for employee Rajesh 350c is encountered, RTOM engine 240 will find that the object exists, both a DDT to a Person object, but also an IDT relating to object CEO. In this example, the constraints allowing deletion of object CEO 2050c will be satisfied, and the deletion of DDT CEO 2050c occurs. And, as a DDT with respect to IDT Person Rajesh, barring other constraints, then deletion of DDT employee 350c also occurs. The result is shown at T9. Here, Person object Rajesh 350p remains, unaltered by deletion of his role as employee. While, in this case, his role as CEO was linked with his role as an employee, his ability to be a member of the board remains, as type Board is dependent only on Person, not Employee.

There could be different constraints. For example, it could be a requirement that at least one other employee with role CEO exists before a CEO (and its associated employee object) are deleted. There could be minimum size requirements for a team, as another example, that would limit deletions of employees of the team once the limit is reached. There are unlimited possible combinations of linked objects customizable to regulate their creation and deletion, and just a subset of illustrative features is identified in FIG. 20.

FIG. 21 (prior art) depicts a general-purpose computing system 2100 that can serve as a client or a server depending on the program modules and components included. One or more computers of the type depicted in computing system 2100 can be configured to perform operations described above. For example, computing system 2100 is suitable to run a compiler such as detailed above in FIGS. 4A and 4B. Computing system 2100 may run program executables 220, in a runtime environment, embodying memory 300 of FIG. 3. Those of skill in the art will appreciate that the invention may be practiced using other system configurations, including hand-held devices, multiprocessor systems, microprocessor-based or programmable consumer electronics, network PCs, minicomputers, mainframe computers, and the like.

Computing system 2100 includes a conventional computer 2120, including a processing unit 2121, a system memory 2122, and a system bus 2123 that couples various system components including the system memory to the processing unit 2121. The system bus 2123 may be any of several types of bus structures, including a memory bus or memory controller, a peripheral bus, and a local bus using any of a variety of bus architectures. The system memory includes read only memory (ROM) 2124 and random-access memory (RAM) 2125. A basic input/output system 2126 (BIOS), containing the basic routines that help to transfer information between elements within the computer 2120, such as during start-up, is stored in ROM 2124. The computer 2120 further includes a hard disk drive 2127 for reading from and writing to a hard disk, not shown, a solid-state drive 2128 (e.g., NAND flash memory), and an optical disk drive 2130 for reading from or writing to an optical disk 2131 (e.g., a CD or DVD). The hard disk drive 2127 and optical disk drive 2130 are connected to the system bus 2123 by a hard disk drive interface 2132 and an optical drive interface 2134, respectively. The drives and their associated computer-readable media provide nonvolatile storage of computer readable instructions, data structures, program modules and other data for computer 2120. Other types of computer-readable media can be used.

Program modules are stored on non-transitory, computer-readable media such as disk drive 2127, solid state disk 2128, optical disk 2131, ROM 2124, and RAM 2125. The program modules include an operating system 2135, one or more application programs 2136, other program modules 2137, and program data 2138. An application program 2136 can use other elements that reside in system memory 2122 to perform the processes detailed above.

A user may enter commands and information into the computer 2120 through input devices such as a keyboard 2140 and pointing device 2142. Other input devices (not shown) may include a microphone, joystick, game pad, satellite dish, scanner, or the like. These and other input devices are often connected to the processing unit 2121 through a serial port interface 2146 that is coupled to the system bus, but may be connected by other interfaces, such as a parallel port, game port, universal serial bus (USB), or various wireless options. A monitor 2147 or other type of display device is also connected to the system bus 2123 via an interface, such as a video adapter 2148. In addition to the monitor, computers can include or be connected to other peripheral devices (not shown), such as speakers and printers.

The computer 2120 may operate in a networked environment using logical connections to one or more remote computers, such as a remote computer 2149. The remote computer 2149 may be another computer, a server, a router, a network PC, a peer device, or other common network node, and typically includes many or all the elements described above relative to the computer 2120, although only a memory storage device 2150 has been illustrated in FIG. 21 for simplicity. The logical connections depicted in FIG. 21 include a network connection 2151, which can support a local area network (LAN) and/or a wide area network (WAN). Such networking environments are commonplace in offices, enterprise-wide computer networks, intranets, cellular data systems, and the Internet in general. Furthermore, network 2151 may connect to any number of distributed systems such as cloud-based storage or other web-based applications.

Computer 2120 includes a network interface 2153 to communicate with remote computer 2149 via network connection 2151. In a networked environment, program modules depicted relative to the computer 2120, or portions thereof, may be stored in the remote memory storage device. It will be appreciated that the network connections shown are exemplary and other means of establishing a communication link between the computers may be used.

The foregoing description of the implementations of the present techniques and technologies has been presented for the purposes of illustration and description. This description is not intended to be exhaustive or to limit the present techniques and technologies to the precise form disclosed. Many modifications and variations are possible in light of the above teaching. It is intended that the scope of the present techniques and technologies are not limited by this detailed description. The present techniques and technologies may be embodied in other specific forms without departing from the spirit or essential characteristics thereof. The modules, routines, features, attributes, methodologies, and other aspects of the present disclosure can be implemented as software, hardware, firmware, or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present techniques and technologies are in no way limited to implementation in any specific programming language, or for any specific operating system or environment. Accordingly, the disclosure of the present techniques and technologies is intended to be illustrative, and not limiting. Therefore, the spirit and scope of the appended claims should not be limited to the foregoing description. In U.S. applications, only those claims specifically reciting “means for” or “step for” should be construed in the manner required under 35 U.S.C. § 112(f).

1. A method of compiling source code having a first data type for defining a first object and a second data type for defining a second object, the second data type referencing the first data type, such that the second object is linked to the first object, the method comprising:
encountering in the source code an object-management construct directed to one of the first or second data types, the object-management construct identifying an object-management function for affecting the one of the first or second objects at runtime;
compiling the object-management construct into type-specific instructions for accessing generic object-management instructions identified by the object-management construct; and
emitting the generic object-management instructions operable with the type-specific instructions to perform at runtime the identified object-management function.

2. The method of claim 1, wherein the generic object-management instructions comprise:
evaluating at least one predetermined criteria in response to encountering at least one of the type-specific instructions; and
executing the object-management function responsive to the predetermined criteria being satisfied.

3. The method of claim 1, wherein the object-management construct comprises at least one of a delete construct, a create construct, and an update construct.

4. The method of claim 1, wherein the generic object-management instructions comprise:
evaluating, in response to a create instruction for the first type, at least one create constraint for the first object; and
creating the first object responsive to the at least one create constraint evaluating to a predefined value.

5. The method of claim 1, wherein the generic object-management instructions comprise:
determining, in response to a create instruction for the first type, whether the first object exists; and
creating the first object responsive to the first object not existing.

6. The method of claim 5, wherein:
the first object corresponding to the create instruction exists having a first set of values; and
the create instruction comprises a second set of values; and
the generic object-management instructions further comprise comparing the first and second sets of values.

7. The method of claim 6, wherein the generic object-management instructions further comprise updating the first object responsive to the comparison not matching.

8-9. (canceled)

10. The method of claim 1, wherein the generic object-management instructions comprise:
determining, in response to a create instruction for the second type, whether the first object exists.

11. The method of claim 10, wherein the generic object-management instructions further comprise:
creating the first object responsive to the first object not existing; and
creating the second object linked to the first object.

12. (canceled)

13. The method of claim 10, wherein:
the first object exists having a first set of values; and
the second type create instruction comprises a second set of values; and
the generic object-management instructions further comprise comparing the first and second sets of values.

14. The method of claim 13, wherein the generic object-management instructions further comprise updating the first object responsive to the comparison not matching.

15-17. (canceled)

18. The method of claim 1, wherein the generic object-management instructions comprise:
evaluating, responsive to an update instruction for one of the first or second objects, at least one update constraint for the one of the first or second objects; and
updating the one of the first or second objects responsive to the at least one update constraint evaluating to a predetermined value.

19. The method of claim 1, wherein the generic object-management instructions comprise:
evaluating, responsive to a delete instruction for the first object, at least one delete constraint for first object; and
deleting the first object responsive to the at least one delete constraint evaluating to a predefined value.

20. (canceled)

21. The method of claim 1, wherein the generic object-management instructions comprise:
determining, responsive to a delete instruction for the first object, whether the second object exists linked to the first object; and
deleting the first object responsive to the second object not existing.

22-26. (canceled)

27. The method of claim 1, wherein the generic object-management instructions comprise:
evaluating, responsive to a delete instruction for the second object, at least one delete constraint for the second object; and
deleting the second object responsive to the at least one delete constraint evaluating to a predefined value.

28. (canceled)

29. A method of executing a computer program, operable with a first data type defining a first object; and a second data type defining a second object, the second data type referencing the first data type, the second object linked to the first object,
the method comprising:
encountering a type-specific object-management instruction identifying an object-management function to affect one of the first or second objects;
accessing generic object-management instructions identified by the object-management function;
evaluating at least one predetermined criterion associated with the one of the first or second objects and the object-management function; and
executing the object-management function responsive to the predetermined criteria being satisfied.

30. The method of claim 29, wherein the object-management function comprises at least one of a delete function, a create function, and an update function.

31. The method of claim 29, wherein the evaluating at least one predetermined criterion comprises evaluating at least one constraint associated with the one of the first or second objects and the object-management function, the executing the object-management function aborting responsive to the at least one constraint evaluating to a predefined value.

32. The method of claim 29, wherein the evaluating at least one predetermined criterion comprises determining whether one of the first or second objects exists.

33. The method of claim 29, wherein:
the one of the first or second objects exists having a first set of values;
the type-specific object-management instruction comprises a second set of values; and
the evaluating at least one predetermined criterion comprises comparing the first and second sets of values.

34. The method of claim 29, wherein the evaluating at least one predetermined criterion comprises:
messaging a user; and
the object-management function is executed responsive to user feedback.
